(19) United States
(12) Patent Application Publication
(10) Pub. No.: US 2002/0107042 A1
(43) Pub. Date: Aug. 8, 2002

(54) Handheld wireless communication device

(76) Inventors: Matthew J. Murnaghan, North Vancouver (CA); Bruce D. Larsen, West Vancouver (CA)

Correspondence Address: ROBERT E. KREBS, THELEN, REID & PRIEST LLP, P.O. BOX 640640, SAN JOSE, CA, 95164-0640, US

(21) Appl. No.: 09/781,107

(22) Filed: Feb. 8, 2001

(51) Int. Cl. H04B 1/38

(52) U.S. Cl. 455/550; 455/557; 455/90

(57) ABSTRACT

A communication device for providing wireless communication for a personal data assistant in a compact package is provided. The communication device of the present invention includes a modem, an interface board and logic. The modem transmits and receives communications for the communication device. The interface board provides connectivity between the communication device and the personal data assistant, thereby allowing a user of the personal data assistant to transmit data using the modem of the communication device. The logic of the communication device periodically activates the modem to check for communications on a server. Furthermore, the communication device of the present invention includes a compact housing, thereby allowing the communication device to have a compact configuration.

### BACKGROUND OF THE INVENTION

1. Field of The Invention

The present invention relates generally to wireless communication devices and more particularly to wireless communication devices for personal data assistants.

2. Description of Related Art

Today, users reliance on wireless communication continues to steadily increase. This reliance includes the use of wireless communication with handheld devices. These devices include Handspring™ Visor™ personal data assistants and Palm™ handheld devices. These handheld devices allow a user to organize data and provide reminders to the user of certain upcoming events such as meetings. In addition, these devices allow a user to wirelessly communicate.

The wireless communication capabilities allow a user to access electronic mail (email), the internet, and other web applications while they are using the handheld device. However, the user is not able to wirelessly communicate during use of an application. For instance, when a user accesses the handheld device, the user typically runs an application, such as an address book function, games or a date book function. Thus, while an application such as the address book is in use, the user may not wirelessly communicate with the handheld device. Instead, the user must end the application and then engage the wireless communication function. As may be appreciated, this interferes with the ability of a user to multitask with the device, such as running an application and checking email at the same.

In addition, as the user runs an application, if the user receives data, such as email, the handheld device does not inform the user of the new mail. The handheld device does not perform periodic checks to ascertain whether or not the user has received new communications. Currently, most handheld devices are single-threaded, thus, in order to determine whether or not new email has been sent, the user must end the application as described and access their email account. As may be appreciated, this prevents efficient use of the handheld device since the user must end an application in use prior to accessing their email account to determine whether or not the user has received email. Furthermore, current handheld devices require custom modems tailored for that specific handheld device. Therefore, greater costs are incurred in designing a specific modem for a particular handheld device. Also, the current modems available for handheld devices have a big footprint resulting from a short and thick configuration. As a result, the handheld device, when coupled with the prior art modems, tends to be cumbersome and difficult to use, thereby negating the handheld aspect of the handheld device due to the large size of the modem.

Therefore, a need to exists to provide a device which allows a user to run an application with a handheld device and wirelessly communicate at the same time. The new device should allow periodic checks of email as the user operates separate functions with the handheld device. In addition, this new device should be compact and use readily available components capable of providing wireless communication to the handheld device.

### BRIEF SUMMARY OF THE INVENTION

The present invention fills the aforementioned needs by providing a compact wireless communication device capable of providing wireless communication for a handheld device. In accordance with one embodiment of the present invention, the wireless communication device periodically checks for message notifications as the user operates another application with the handheld device.

In one embodiment of the present invention, a wireless communication device which provides communication capability for a personal data assistant is disclosed. The wireless communication device includes a housing, a modem within the housing, and logic in communication with the modem. The modem provides communication capability for the wireless communication device such that a user of the personal data assistant may communicate wirelessly while using the personal data assistant. The logic is adapted to check if a server has communications for a user while the user operates another application on the personal data assistant. In accordance with one embodiment of the present invention, if the logic determines that the server has communications, the user is notified.

In another embodiment of the present invention, a handheld communication device which provides wireless communication capability for a personal data assistant is disclosed. The handheld communication device includes a modem, logic and an indicator. The modem provides wireless communication for the personal data assistant as a user operates applications on the personal data assistant. The logic, which is in communication with the handheld communication device via an interface, checks for message notifications. The logic periodically checks for communications while the user operates another application on the personal data assistant. If the logic determines that the user has received communications, the logic activates the indicator which indicates to the user that the presence of communications.

In a further embodiment of the present invention, a communication device for providing wireless communication for a personal data assistant is disclosed. The communication device includes a modem, an interface and logic in communication with the communication device. The modem receives and transmits data for the communication device. The interface provides connectivity between the communication device and the personal data assistant such that a user of the personal data assistant may receive and transmit data from the personal data assistant using the modem. The communication device also includes logic. The logic periodically checks for message notifications while the user runs another application on the personal data assistant.

Therefore, as may be appreciated, the present invention provides a wireless communication device for personal data assistants. The present invention allows for automatic, periodic checking of communications while a user is operating another application on the personal data assistant.

### BRIEF DESCRIPTION OF THE SEVERAL VIEWS OF THE DRAWING(S)

Many advantages of the present invention will be apparent to those skilled in the art with a reading of this specification in conjunction with the attached drawings, wherein like reference numerals are applied to like elements and wherein:

FIG. 1 is an embodiment of the present invention illustrating a handheld device communicating with a server via a wireless communication device.

FIG. 2 is an exploded perspective view of the wireless communication device shown with respect to FIG. 1, where internal components of the wireless communication device are more clearly shown, in accordance with one embodiment of the present invention.

FIG. 3 illustrates a block diagram of the wireless communication device shown with reference to FIG. 2, in accordance with one embodiment of the present invention.

FIG. 4 is a perspective view of the wireless communication device shown with reference to FIG. 1, in accordance with one embodiment of the present invention.

### DETAILED DESCRIPTION OF THE INVENTION

The present invention is a device for a wireless communication device for a handheld device. As an overview, the present invention discloses a wireless communication device having a wireless modem which interfaces with a handheld device. The wireless communication device provides wireless communication capabilities for the handheld device. As will be discussed in greater detail with respect to the accompanying Figures, the wireless modem performs periodic checks to determine if a server has message notifications for a user. Additionally, the wireless communication device of the present invention includes a stream-lined, compact design. As such, the wireless communication device of the present invention easily fits within a user's hand.

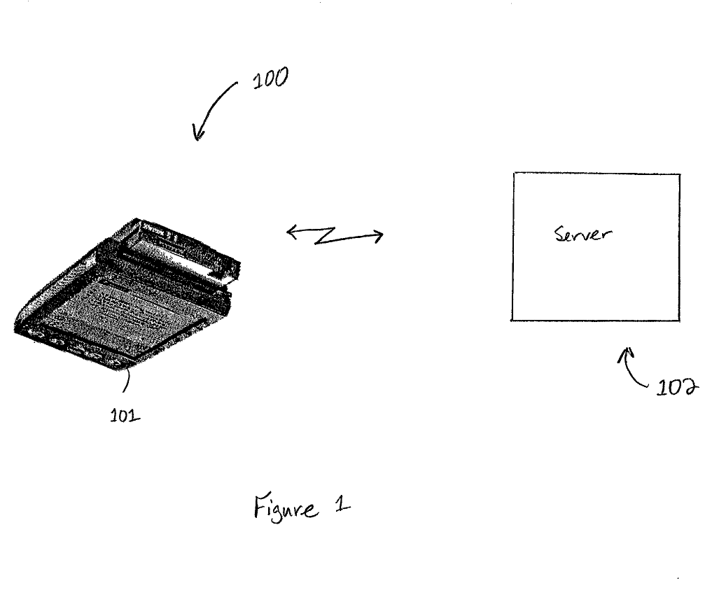

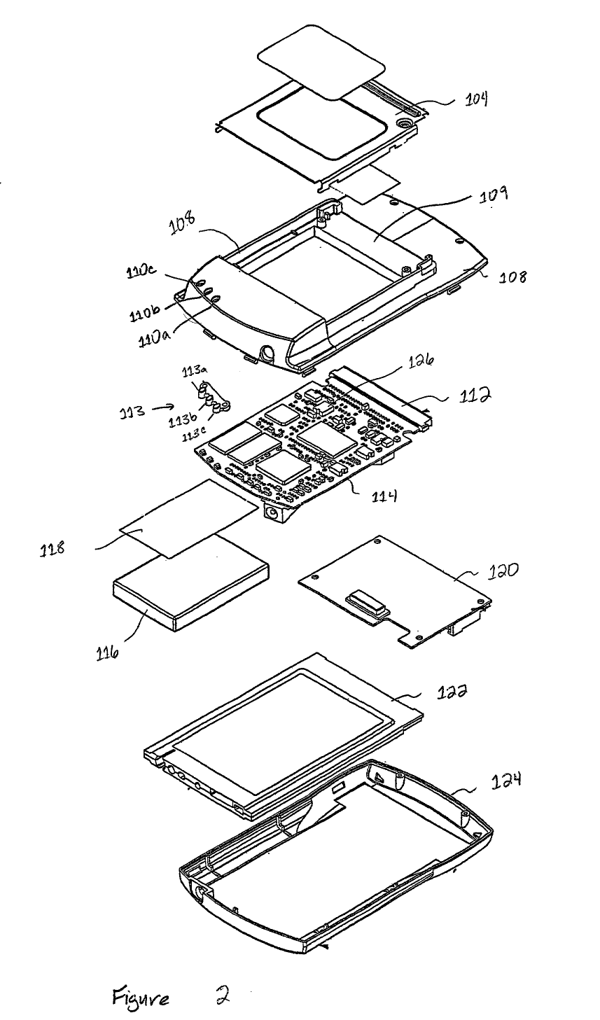

Now making reference to the Figures, and more particularly FIG. 1, FIG. 1 shows a handheld device 101 communicating with a server 102. In accordance with one embodiment of the present invention, a wireless communication device 100 may be a module capable of facilitating wireless communication for the handheld device 101 shown with reference to FIG. 1. The handheld device 101 may be any device capable of serving as a personal data assistant (PDA), such as a Handspring™ Visor™ personal data assistant, a Palm™ handheld device or the like. The server 102 may be any remote or local device suitable for transmitting and receiving data. In accordance with one embodiment of the present invention, the server 102 includes communications and message notifications. A message notification indicates that a user has communications, such as electronic mail or the like, on the server 102. The handheld device 101 wirelessly communicates with the server 102 using the wireless communication device 100. Internal components of the wireless communication device 100, as more clearly shown with reference to FIG. 2, facilitate wireless communication of the handheld device 101.

FIG. 2 is an exploded perspective view of the wireless communication device 100 shown with respect to FIG. 1, where internal components of the wireless communication device 100 are more clearly shown. As may be seen with respect to the Figure, the wireless communication device 100 includes a top metal cover 104. The top metal cover 104 allows access to the wireless communication device 100 when needed for maintenance or the like. The top metal cover 104 also seals off a top housing 108.

The top housing 108 houses various components of the wireless communication device 100. The top housing 108 may be formed out of any material suitable for forming a lightweight housing, such as plastic or the like. The top housing 108 includes a lip 109 which is configured to allow the wireless communication device 100 to interface with the handheld device 101. In addition to the lip 109, the top housing 108 also includes LED ports 110a through 110c. The LED ports 110a through 110c allow viewing of an indicator, such as a LED 113, by a user of the wireless communication device 100. The LED 113 includes LEDs 113a through 113c which indicate the status of various functions performed by the wireless communication device 100. Among the functions indicated by the LEDs 113a through 113c include the battery life of a battery 116 and whether or not a user using the wireless communication device 100 has a message notification. In addition, the LEDs 113a through 113c perform the function of indicating whether or not a modem 122 of the wireless communication device 100 is communicating.

As described earlier, the top housing 108 houses various components of the wireless communication device 100. Among the components the top housing 108 houses is an interface board 114. The interface board 114 provides an electrical and a mechanical interface between the wireless communication device 100 and the handheld device 101. The interface board 114 includes a connector 112 which, along with the lip 109, allows electrical and mechanical interfacing between the wireless communication device 100 and the handheld device 101. In one embodiment of the present invention, the connector 112 may be an expansion slot which facilitates coupling of the wireless communication device 100 with the handheld device 101.

In addition to providing an electrical and mechanical interface between the wireless communication device 100 and the handheld device 101, the interface board 114 also interfaces the modem 122 with the wireless communication device 100 and controls the modem 122. The modem 122 provides wireless communication capability to the wireless communication device 100. The modem 122 may be any standard PCMCIA card capable of supporting a range of communication protocols to the wireless communication device 100, including cellular digital packet data (CDPD), code-division multiple access (CDMA) or the like. In one embodiment of the present invention, the modem 122 may be an AirCard300™ available from Sierra Wireless of Richmond, British Columbia, Canada. The modem 122 rests within the wireless communication device 100 in a bottom housing 124. The bottom housing 124 encloses the modem 122 and forms a bottom portion of the wireless communication device 100 such that the bottom housing 124, when coupled with the top housing 108, forms the wireless communication device 100 into a single unit. The top and bottom housings 108 and 124 may be coupled with each other using any technique suitable for coupling two members, such as threaded fasteners or the like. The bottom housing 124 may be formed out of the same material as the top housing 108, such as plastic or the like. It should also be noted that the top and bottom housings 108 and 124 are configured such that the top and bottom housings 108 and 124 form the wireless communication device 100 into a streamlined, compact design.

As described earlier, in accordance with one embodiment of the present invention, the modem 122 may use a CDPD communication protocol. In this embodiment, the functionality of the CDPD communication protocol resides on the interface board 114. Likewise, the protocol stack for the CDPD communication protocol resides on the interface board 114. In addition to providing the necessary functionality and protocol stack for the CDPD communication protocol, the interface board 114 also includes the required circuitry for a battery charger and the battery 116. The battery 116 is an on board power source which may be any suitable power source capable of providing power to the wireless communication device 100. In accordance with one embodiment of the present invention, the battery 116 may be a 3.8 volt lithium ion battery capable of providing 700 mAh of power. The battery 116 interfaces with the interface board 114 and the wireless communication device 100 with a double-sided adhesive 118.

In one embodiment of the present invention, the wireless communication device 100 periodically checks if the server 102 has received any message notifications for communications, such as electronic mail (email). The wireless communication device 100 periodically checks for communications using a wake-up function controlled using logic such as a mini microchip 126. The mini microchip 126 provides the necessary functionality to allow the modem 122 to periodically check at regular intervals for communications. The mini microchip 126 may be any standard single chip microcontroller such as an Atmel™ Tiny Micro™, available from Atmel Corporation, located in San Jose, Calif., or the like, capable of providing functionality which allows the modem 122 to periodically checks for message notifications on the server 102. In alternative embodiments of the present invention, the logic may also be an application specific integrated circuit (ASIC), programmable logic, a processor, a field programmable gate array (FPGA) or the like. It should be noted that the wake-up function checks for communications and message notifications regardless of whether or not the modem 122 is connected to the handheld device 101. Therefore, the mini microchip 126 automatically checks for communications stored on the server 102. When the mini microchip 126 determines there are new communications, the mini microchip 126 activates the LED 113a. The mini microchip 126 activates the LED 113a by simultaneously flashing the LEDs 113a through 113c.

The mini microchip 126 may also provide advanced power management in one embodiment of the present invention. If the mini microchip 126 determines that the modem 122 is not in use, the mini microchip 126 may go into a power down mode, where a minimal amount of battery power is used while the modem 122 is not communicating. In one embodiment of the present invention, the mini microchip 126 also monitors the voltage of the battery 116. Thus, as the voltage of the battery 116 drops and the amount of available power decreases, the mini microchip 126 activates one of the LEDs 113a through 113c in order to indicate to a user of the handheld device 101 that the power of the battery 116 is low. It should also be noted that when the wireless communication device 100 is coupled with the handheld device 100, the mini microchip 126 indicates to a user via the handheld device 101, such as on a screen of the handheld device 101, the voltage level of the battery 116.

In addition to the mini microchip 126, the wireless communication device 100 also includes a connector board 120. The connector board 120 is an interface between the modem 122 and the interface board 114. The connector board 120 is configured to provide mechanical offset between the modem 122 and the interface board 114 such that modem 122 and the interface board 114 may compactly fit within the top and bottom housings 108 and 124, thereby facilitating a compact design for the wireless communication device 100.

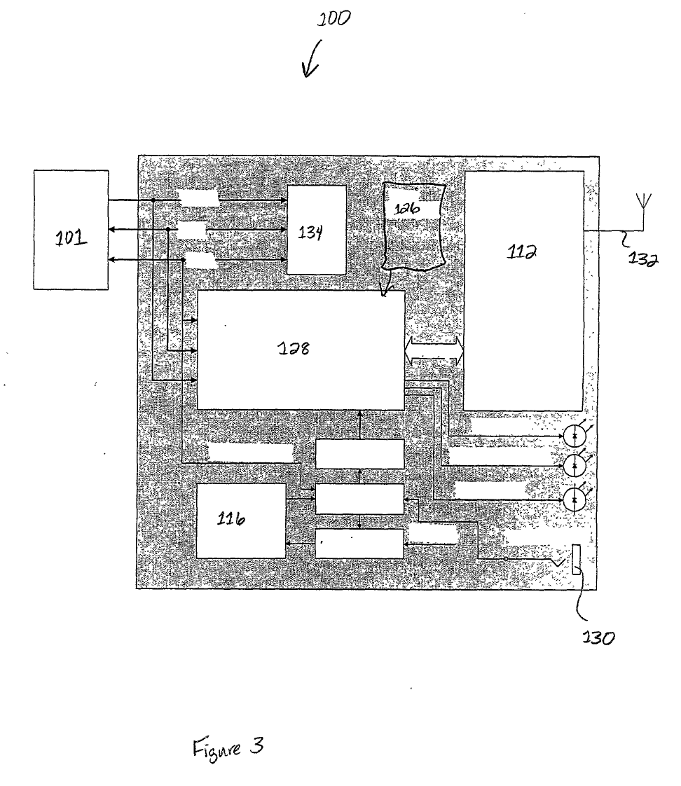

Now making reference to FIG. 3, FIG. 3 illustrates a block diagram of the wireless communication device 100 shown with reference to FIG. 2. As may be seen with reference to FIG. 3, the wireless communication device 100 also includes custom interface circuitry 128, a battery charger input 130, an antenna 132 and an application ROM 134. The custom interface circuitry 128 provides the previously described electrical interface on the interface board 114 between the modem 122 and the handheld device 101. The custom interface circuitry 128 also controls the LEDs 113a through 113c. Therefore, when the modem 122 transmits or receives data, the custom interface circuitry 128 activates the LED 113a. Moreover, when the modem has successfully connected to a CDPD network in order to transmit data, the custom interface circuitry 128 activates the LED 113b to inform a user that the modem 122 is successfully registered.

The custom interface circuitry 128 also monitors the voltage of the battery 116. For example, if the battery 116 contains a full charge, the custom interface circuitry 128 activates the LED 113c. If the battery 116 has a low charge, the custom interface circuitry causes the LED 113c to rapidly flash. If the battery 116 is being charged by the battery charger input 130, the custom interface circuitry 128 causes the LED 113c to flash at a rate slower than when the battery has a low voltage. Additionally, the custom interface circuitry 128 also controls battery charging by the battery charger input 130.

The battery charger input 130 is used with a DC power adapter. The DC power adapter may be any direct current power adapter such as a 5 volt dc 2 amp switching supply or the like which is suitable for charging the battery 116 while simultaneously allowing operation of the modem 122 using the battery charger input 130. It should be noted that the wireless communication 100 may be charged while the wireless communication device 100 is either in communication with the handheld device 101 or not in communication with the handheld device 101.

The wireless communication device 100 also includes the antenna 132. The antenna 132 facilitates communication of the modem 122 with the server 102. In one embodiment of the present invention, the antenna 132 is detachable from the wireless communication device 100, such that damage to the antenna 132 while the wireless communication device 100 is not in usage may be prevented.

As previously mentioned, the wireless communication device 100 also includes an application ROM 134. The application ROM 134 interfaces directly with the handheld device 101 via the connector 112. The application ROM 134 includes software executed by the handheld device 101 which controls hardware, such as the interface board 114, in addition to running applications such as email and internet access. In one embodiment of the present invention, the application ROM 134 may be a 3.3 vdc device that may accommodate various sizes, such as 1M×16, 2M×16, 4M×16, or the like.

It should be noted that the custom interface circuitry 128 also includes software which is necessary to operate the wireless communication device 100. This software includes setup applications and welcome applications in addition to the previously described software stored by the application ROM 134. In accordance with one embodiment of the present invention, the setup applications allow the installation of software and hardware necessary to properly operate the wireless communication device 100. This software includes those applications stored on the application ROM 134, the modem 122 and the interface board 114. Moreover, the software uninstalls the software if hardware is removed. Upon installation of the wireless communication device 100 into the handheld device 101, the setup application initializes the hardware and the software of the wireless communication device 100. Once the setup application completes the initialization procedure, the setup application launches the welcome application. The welcome application points out other application to be run on the handheld device 101, such as modem initialization.

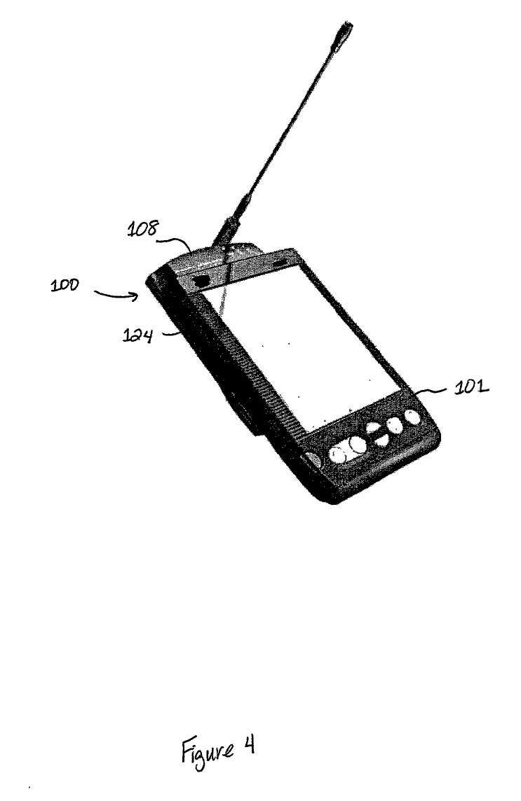

Now making reference to FIG. 4, FIG. 4 is a perspective view of the wireless communication device 100 shown with reference to FIG. 2. As may be seen with respect to the Figure, the wireless communication device 100 is compact such that when the wireless communication device 100 is coupled with the handheld device 101, the overall package is not cumbersome, as described with reference to the prior art. The configuration of the top and bottom housing 108 and 124 provides the compact configuration for the wireless communication device 100, thereby making the wireless communication device 100 less cumbersome. Likewise, as previously described, the connector board 120 interfaces the interface board 114 with the modem 122 in a compact configuration within the wireless communication device 100.

The present invention now provides multi-tasking capabilities to a handheld device having wireless communication capabilities. As such, a user of a handheld device having the present invention may check if they have received any communications while they are running another application. Furthermore, the wireless communication device of the present invention preserves the handheld nature of handheld devices since the present device compact and trim, thereby making the overall package of the handheld device and the wireless communication device less cumbersome. Moreover, the present invention automatically checks for communications on a remote server while the modem is not in use with a mini microchip controller. Thus, the present invention automatically notifies a user of received communications while the user works with another application.

The above are exemplary modes of carrying out the invention and are not intended to be limiting. It will be apparent to those of ordinary skill in the art that modifications thereto can be made without departure from the spirit and scope of the invention as set forth in the following claims.

What is claimed is:

1. A wireless communication device which provides communication capability for a personal data assistant, the device comprising:
a housing;
a modem within the housing, where the modem provides communication capability for the wireless communication device; and
logic in the housing adapted to check for communications.

2. A wireless communication device as recited in claim 1, the device further comprising:
an interface board which provides connectivity between the modem and the personal data assistant.

3. A wireless communication device as recited in claim 2, wherein the communications is electronic mail.

4. A wireless communication device as recited in claim 1, wherein the personal data assistant is a hand-held data organizer.

5. A wireless communication device as recited in claim 1, the device further comprising:
a battery for providing power to the wireless communication device.

6. A wireless communication device as recited in claim 2, the device further comprising:
a connector board for providing electrical connectivity between the modem and the interface board.

7. A wireless communication device as recited in claim 6, wherein the connector board provides mechanical offset between the modem and the interface board.

8. A wireless communication device as recited in claim 7, wherein the mechanical offset allows the modem and the interface board to fit compactly within the wireless communication device.

9. A wireless communication device as recited in claim 5, the device further comprising:
a LED light, where the LED light indicates the charge of the battery.

10. A wireless communication device as recited in claim 1, the device further comprising:
a LED light, where the LED light indicates if the modem has received data.

11. A wireless communication device as recited in claim 1, the device further comprising:
a LED light, where the LED light indicates if the modem has transmitted data.

12. A wireless communication device as recited in claim 1, the device further comprising:
a LED light, where the LED light indicates if the modem is registered.

13. A wireless communication device as recited in claim 1, the device further comprising:
a LED light, where the LED light flashes to indicate a server has communications.

14. A wireless communication device as recited in claim 1, wherein the modem is a cellular digital packet data (CDPD) modem.

15. A wireless communication device as recited in claim 1, wherein the logic is a mini microchip.

16. A wireless communication device as recited in claim 1, wherein the logic periodically checks for message notifications.

17. A wireless communication device as recited in claim 16, wherein the message notifications indicates that a server has communications for a user.

18. A wireless communication device as recited in claim 17, wherein the logic periodically checks for message notifications while the modem is not in use.

19. A wireless communication device as recited in claim 1, wherein the housing provides a compact configuration for the wireless communication device.

20. A wireless communication device as recited in claim 1, wherein the logic is a field programmable gate array (FPGA).

21. A wireless communication device as recited in claim 1, wherein the logic is an application specific integrated circuit (ASIC).

22. A wireless communication device as recited in claim 1, wherein the logic is a processor.

23. A wireless communication device as recited in claim 1, wherein the logic is programmable logic.

24. A wireless communication device as recited in claim 17, wherein the logic periodically checks for message notifications while the modem is in a powered down state.

25. A wireless communication device as recited in claim 1, the device further comprising:
a detachable antenna coupled with the wireless communication device, where the detachable antenna may be detached when the wireless communication device is not in use.

26. A handheld communication device which provides wireless communication capability for a personal data assistant, the device comprising:
a modem for providing wireless communication for the personal data assistant;
logic in communication with the handheld communication device, where the logic checks for message notifications; and
an indicator which is activated when the logic determines that the modem has received communications.

27. A handheld communication device as recited in claim 26, the device further comprising:
an interface board for connectivity between the handheld communication device and the personal data assistant.

28. A handheld communication device as recited in claim 27, the device further comprising:
a housing which encloses the interface board, the modem and the logic, where the housing provides a compact configuration for the handheld communication device.

29. A handheld communication device as recited in claim 28, the device further comprising:
a connector board which provides mechanical offset between the interface board and the modem such that interface board and the modem fit compactly within the housing of the handheld communication device.

30. A handheld communication device as recited in claim 26, wherein the personal data assistant is a handheld data organizer.

31. A handheld communication device as recited in claim 26, wherein the indicator is activated while the personal data assistant is running another application.

32. A handheld communication device as recited in claim 26, wherein the logic checks for communications received by the modem while the personal data assistant is running another application.

33. A handheld communication device as recited in claim 26, wherein the indicator is an LED.

34. A handheld communication device as recited in claim 26, the device further comprising:
a detachable antenna attached to the handheld communication device.

35. A handheld communication device as recited in claim 26, wherein the message notifications indicate when a user receives communications.

36. A communication device for providing wireless communication for a personal data assistant, the device comprising:
a modem for receiving communications;
an interface in communication with the personal data assistant where the interface provides connectivity between both the communication device and the personal data assistant; and
logic in communication with the communication device, where the logic checks if communications have been received.

37. A communication device as recited in claim 36, the device further comprising:
a housing having a compact configuration enclosing the modem, the interface and the logic, where the compact configuration of the housing provides a compact configuration for the communication device.

38. A communication device as recited in claim 36, wherein the logic periodically checks for received communications while a user of the personal data assistant is running another application.

39. A communication device as recited in claim 36, wherein the personal data assistant is a handheld data organizer.

40. A communication device as recited in claim 36, wherein the logic is a mini microchip.

41. A communication device as recited in claim 37, wherein the logic activates an indicator if communications have been received.

42. A communication device as recited in claim 41, wherein the indicator is a LED.

43. A communication device as recited in claim 36, wherein the logic is a field programmable gate array (FPGA).

44. A communication device as recited in claim 36, wherein the logic is programmable logic.

45. A communication device as recited in claim 36, wherein the logic is an application specific integrated circuit (ASIC).

46. A communication device as recited in claim 36, the device further comprising:
a detachable antenna attached to the communication device.
